(19) United States
(12) Patent Application Publication
(10) Pub. No.: US 2003/0072037 A1
(43) Pub. Date: Apr. 17, 2003

(54) System and method for imprinting a digital image with an identifier using black metamers

(76) Inventor: Jon W. Hamilton, Austin, TX (US)

Correspondence Address: ROBERTS ABOKHAIR & MARDULA, SUITE 1000, 11800 SUNRISE VALLEY DRIVE, RESTON, VA, 20191, US

(21) Appl. No.: 10/232,470

(22) Filed: Aug. 30, 2002

Related U.S. Application Data
(60) Provisional application No. 60/316,020, filed on Aug. 31, 2001.

(51) Int. Cl. B41J 1/00; G06F 15/00

(52) U.S. Cl. 358/3.28; 358/1.9

(57) ABSTRACT

A system and method for imprinting a digital image with an identifier using black metamers. Black metamers provide an addition to the radiometric signature of the original digital image that is imperceptible to human vision. The identifier may include, but is not limited to, watermarks, fingerprints, textual additions, steganography and identification tags. The digital image is processed and imprinted frame by frame by adding black metamers to the fundamental metamer of selected pixels in a frame. The black metamers imprint the identifier into the digital image without changing the way in which the image is perceived visually. To verify that a copy of a digital image imprinted with an identifier has been made, the suspected copy of the digital image is stripped of all fundamental metamers to reveal only its black metamers. The presence of an identifier within the black metamers is evidence that the suspected copy is in fact a copy of a digital image.

### CROSS REFERENCE TO RELATED APPLICATIONS

This application claims priority under 35 U.S.C. § 119(e) from provisional application No. 60/316,020, filed Aug. 31, 2001. The 60/316,020 provisional application is incorporated by reference herein, in its entirety, for all purposes.

### FIELD OF INVENTION

The present invention relates generally to data protection. More specifically, the present invention relates to a system and method for imprinting a digital image with an identifier in a way that is imperceptible to human vision..

### BACKGROUND OF THE INVENTION

Digital images are inherently easy to copy, modify, and/or distribute. These attributes of digital images make such images an increasingly popular media for the visual arts. On the other hand, digital images often represent significant investments, both in terms of resources and capital. The same factors that make digital images an attractive media also make them susceptible to piracy and malicious use. For this reason, originators of digital images are increasingly seeking ways of protecting their works against unauthorized copying, modification, and/or distribution.

One approach to copy protection of digital images is to add an identifier (e.g., watermarks, fingerprinting, textual additions, steganography and identification tags) to the digital image to identify pirated copies of the digital images. Typically, identifiers are obvious labels asserting ownership or, more subtly, hidden data which can be used to establish improper use. With the advent of digital images and readily available tools for altering digital images, the obvious labels are quite easily removed. If hidden data alters the image in a discernable way, it is also easily removed with the same tools. Therefore this data must be cleverly inserted in areas of the image where it will not be apparent. In order to do this successfully, the image must be studied carefully to identify such areas and an identifier designed in such a way that it will not be noticeable by a potential pirate but can be easily found by the originator. The imposition of such a identifier is, therefore, a time consuming and laborious process that can be efficiently applied to only a limited number of digital images.

In 1666, Isaac Newton performed a series of experiments that he reported to the Royal Society of London in a letter that they published in 1672. Newton reports that he used his prisms and a “small hole in my window-shuts to let in a convenient quantity of the Suns light . . . ” He wrote: “There are therefore two sorts of Colours. The Original or primary (spectral) colours are Red, Yellow, Green, Blew, and a Violet-purple . . . The same colours in specie . . . may also be produced by composition: For, a mixture of Yellow and Blew makes Green; of Red and Yellow makes Orange . . . and by what modes or actions it produceth in our minds the Phantasms of Colours, is not so easie.”

In the nineteenth century when scientists conducted extensive studies of colors and how they were formed, they discovered that Newton's observation that this was “not so easie” was certainly true. They found that not only did the mixing of colors produce a different color, but different mixtures might very well produce colors indistinguishable from each other. Wilhelm Ostwald, the first Nobel Laureate in Chemistry, in his 1919 Physikalische Farbenlehre defines metameric colors as those which evoke equivalent sensations despite different wavelength compositions.

In a series of papers, beginning in the Winter of 1982 in the American Journal of Psychology, Josef B. Cohen and William E. Kappauf of the University of Illinois at Champaign-Urbana addressed this issue in a rigorous mathematical fashion and defined black metamers to be those difference terms obtained by subtracting color mixtures producing indistinguishable colors. What they found was that the three-dimensional space formed by color mixtures was the direct sum of a color stimulus space and a space consisting of black metamers. They speak of orthonormal bases for fundamental metamers.

What is needed is a system and method for imprinting a digital image with an identifier using black metamers that is effective, undetectable by potential pirates, discernable to the originator, and cost effective to implement.

### SUMMARY OF THE INVENTION

The present invention is embodied as method of imprinting a digital image with an identifier using black metamers. The present invention may also be embodied as a method of passing messages or digital data among authorized individuals.

It is an object of the present invention to provide a means to imprint a digital image with an identifier in a manner that cannot be detected and that can be used to detect instances of unauthorized use or piracy.

It is a further object of the present invention to provide a secure means of passing secret messages among authorized individuals.

It yet another object of the present invention to provide a secure means of passing digital data among authorized individuals.

These and other objectives of the present invention will become apparent from a review of the general and detailed descriptions that follow. The present invention provides a method for imprinting a digital image with an identifier using black metamers. The identifier may include, but is not limited to, watermarks, fingerprints, textual additions, steganography and identification tags. The digital image is processed and imprinted frame by frame. The originator of the digital image selects the identifier to be added to the original copy. Any amount of data and any method of addition are admissible under the present invention.

The present invention imprints a digital image with an identifier using black metamers. Black metamers provide an addition to the radiometric signature of the original digital image that is imperceptible to human vision.

After the originator has selected the identifier (for example, and not as a limitation, text and/or image data) to be added to the original copy, a template is developed which prescribes the individual pixels in a frame of image data that required modification. The present invention then converts the encoding of the original copy to fundamental metamers. Next a black metamer is selected and added to the original copy so as to imprint the image with the selected identifier. In the imprinted copy, only the pixels selected by the template chosen by the originator are modified. All of the other pixels contained in the original copy remain unmodified so that their radiometric signatures are identical to the original radiometric signatures.

To verify the unauthorized use of the imprinted digital image, a suspected unauthorized copy of the imprinted image is stripped of all fundamental metamers to reveal only the black metamers. The presence of black metamers in any copy of the original image is prima facie evidence that an unauthorized copy has been made. Depending on the content of the identifier, the identifier imprinted into the unauthorized copy can be recovered and used to determine when and where the unauthorized copy was made. For example, the identifier may include a time and date stamp and a projection location code.

One advantage of the present invention is that the addition of black metamers to the original digital image copy is imperceptible to human vision. Using black metamers allows an undetectable identifier to be placed anywhere within any digital image thereby precluding the requirement for preanalysis. This increases the efficiency of the process by permitting the imposition of the same or different identifiers upon any number of digital images with no consideration of what identifier is placed upon which image.

In addition, there is no known technique that can be used to detect the presence of an identifier, much less remove it, that does not use the original image. As a consequence, this technique can be used for steganography, the process wherein secret messages are hidden in innocuous images passed between two or more people. The sender takes an image, which both the originator and the recipient(s) have, and places a secret message within the image using black metamers. The recipient subtracts the pristine image from the received image to obtain the secret message. Any interceptor of the message would see only the image and could not detect the presence of the hidden message much less the content. In another embodiment of the present invention, the “message” is digital content. By way of illustration and not as a limitation, the digital content can include text, video, executable code, and audio information.

### BRIEF DESCRIPTION OF THE DRAWINGS

A better understanding of the present invention will be realized from the detailed description that follows, taken in conjunction with the accompanying drawings, in which:

FIG. 1 is a graphical representation of radiometric functions, metamers, and fundamental metamers.

FIG. 2 is a graphical representation of black metamers.

FIG. 3 is a block diagram illustrating an overview of an embodiment of the present invention.

FIG. 4 is block diagram illustrating the parameters of a digital image generated by the originator.

FIG. 5 is a flow diagram illustrating the generation of a template for the black metamers selected by the originator.

FIGS. 6A and 6B are a flow diagram illustrating a process of converting the original digital copy into metameric coordinates.

FIG. 7 is a flow diagram illustrating a process for development of an “R” matrix.

FIG. 8 is a table containing an example of an “A” matrix used in an embodiment of the present invention.

FIG. 9 is a table containing an example of an “R” matrix used in an embodiment of the present invention.

FIG. 10 is a flow diagram illustrating a procedure for generating and then selecting a black metamer.

FIG. 11 is a flow diagram illustrating a procedure for imprinting a digital image with an identifier using black metamers according to prescription of a template.

FIG. 12 is a flow diagram illustrating a process of determining whether an image is a copy of an original image.

### DETAILED DESCRIPTION OF THE INVENTION

Because of the uniqueness of the present invention, a list of terms and concepts used in the detailed description is provided below.

Black metamer—A black metamer produces no color sensation and has a tristimulus value of (0,0,0). Mathematically, the set of all black metamers is a vector space under matrix addition and multiplication by real numbers.

Color space—a three-dimensional color model that represent color numerically along an x, y and z axis, the values of which are referred to as tristimulous values.

Fingerprint—a watermark consisting of textual data.

Funadamental metamer—a metamer that is unique for stimuli evoking a given color sensation that produce the same color sensation for human vision.

Munsell chip—a collection of colored chips arranged according to hue, value and chroma color. The color of any surface can be identified by comparing it to the chips, under proper illumination and viewing conditions. The color is then identified by its hue, value and chroma.

Metamer—a mixture of colors that produces a color that evoke equivalent sensations in humans despite different wavelength compositions. In any set of metameric stimuli, the radiometric functions are different, the fundamental metamers are identical, and the color sensation for human vision is the same.

Radiometric function—a function that specifies the physical components of any visual stimulus. A radiometric function expresses the magnitude of energy at each wavelength in the visible spectrum, approximately from 400 nm to 700 nm. A radiometric function may be a single line, corresponding to a monochromatic stimulus, or several lines, or even continuous across the visible spectrum.

Steganography—the art and science of hiding information by embedding messages within other messages. Where digital images are used as the vehicle for passing the message, steganography comprises replacing bits of data with bits of different, invisible information.

Tristimulous value—the value assigned to a color in a color space wherein the values represent hue, saturation and brightness or levels of intensity.

Template—a pixel map giving the coordinates of all the pixels that require modification by black metamers. If a single frame of imagery data consists of Nrows and Ncolumns of pixels, then a template pixel map, TMP, is defined by the following equation:

$$TMP ( I , J ) = \{ \begin{matrix} 0 & no black metamer \\ 1 & add black metamer\end{matrix} \}$$

$$where I = 1 , … , Nrows$$

$$and J = 1 , … , Ncolumns$$

Watermark—a visual addition to the image color coordinates. It may be a specific design or a random pattern.

Additionally, in the description of the present invention which follows, reference is made to the following: (1) Jozef B. Cohen and William E. Kappauf, “Color Mixture And Fundamental Metamers: Theory, Algebra, Geometry, Application,” which appeared in the American Journel of Psychology Vol 98, No. 2 pp 171-259; (2) Jozef B. Cohen and William E. Kappauf “Metameric Color Stimuli, Fundamental Metamers, and Wyszecki's Metameric Blacks” which appeared in the American Journal of Psychology Vol 95, No. 4 pp 537-564.

Digital images comprise picture elements or pixels. An image will comprise some number of pixels along the horizontal axis and some other number along the vertical axis. For example a 600×800 image would have 480,000 total pixels. Each pixel has a number associated with it that enables its color to be expressed. Typically this might be a 24 bit number, the first 8 bits representing the red value, the second 8 bits the green value, and third 8 bits giving the blue value, but this is not meant as a limitation. There are a number of standards specifying the wavelength and intensity of the reds, greens, and blues used and sometimes other colors are used instead. In general for the digital case, the standards are determined by the technical characteristics of the display used. The dominant display is currently color CRTs, although this is not meant as a limitation. Other displays are are also commonly used, including plasma and LCD displays. These standards are specified in general by the Internationale de l'Eclairage (CIE) (also known as the International Commission on Illumination).

As an example of a color image taken by a digital camera will help illustrate the way pixels are assigned color values. In this example, the camera measures the red, green, and blue values for each pixel in accordance with the technical characteristics of the camera employed. That is, the values are assigned in accordance with the standard implemented in the camera. For a given standard, there is a matrix “R” which allows the fundamental metamer for any color mixture to be determined.

A radiometric function specifies the physical components of any visual stimulus. A radiometric function expresses the magnitude of energy at each wavelength in the visible spectrum, approximately from 400 nm to 700 nm. A radiometric function may be a single line, corresponding to a monochromatic stimulus, or several lines, or even continuous across the visible spectrum.

Metameric color stimuli evoke color sensations identical in respect to each of the tristimulous values (hue, brightness, and saturation). However, metameric color stimuli have different spectral compositions, often strikingly different. Therefore the radiometric functions of metameric color stimuli are different. A fundamental metamer is a metamer that is unique for stimuli evoking a given color sensation. In other words, the fundamental metamer is the same for the set of all metamers that produce the same color sensation for human vision. Thus in any set of metameric stimuli, the radiometric functions are different, the fundamental metamers are identical, and the color sensation for human vision is the same.

Within a given set of metamers, each metamer comprises a fundamental metamer and a black metamer. A black metamer produces no color sensation and has a tristimulous value of (0,0,0). Mathematically, the set of all black metamers is a vector space under matrix addition and multiplication by real numbers.

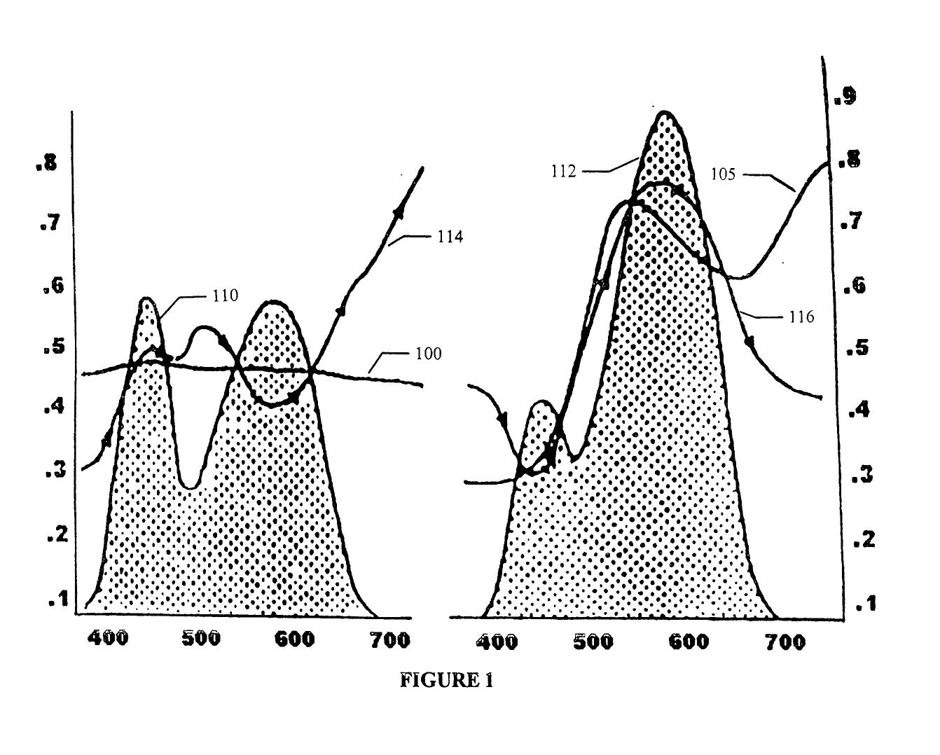

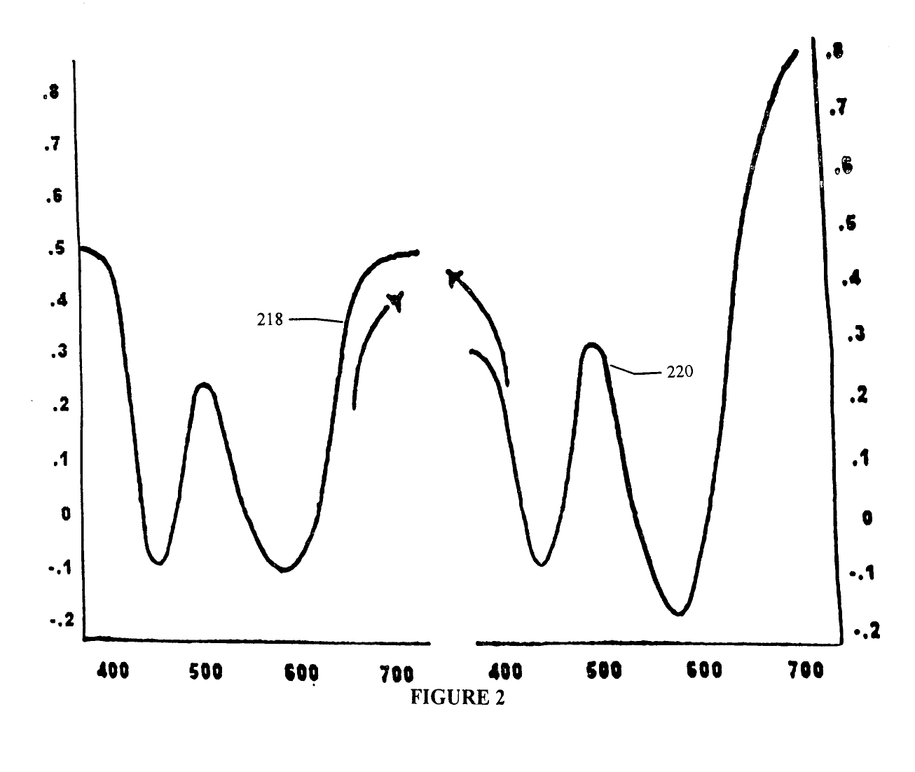

FIG. 1 illustrates how different metameric stimuli within the same set of metameric data produces the same fundamental metamer. Two different radiometric functions 100 and 105 are presented in FIG. 1. One function 100 corresponds to the gray color specified by Munsell N 7, whereas the other 105 represents the Munsell GY 9/5, which is a green-yellow color. Each function within FIG. 1 contains 2 distinct metamers from the set of metamers, including in each case the fundamental metamer 110, 112, and the fundamental metamer plus the black metamer 114 and 116. In FIG. 2, the black metamer 218 and 220 of Munsell N 7 and Munsell GY 9/5 are shown.

The matrix “A” is a k×3 matrix of basic empirical additive color matching data. The k rows are k segments of an equal energy spectrum, each segment representing a monochromatic stimulus at unit energy. The columns represent three arbitrary primaries. An example of such a matrix A appeared in Cohen and Kappauf, Metameric Color Stimuli (1982) (herein, Cohen and Kappauf).

Given a matrix A with 3 specific primaries, then another matrix A₁, which is also a color matching matrix with different primaries can be obtained from the following equation, where the 3×3 matrix T has a nonzero determinant:

AT=A (1)

All the color-matching matrices A represent the matching of an equal energy spectrum. In addition the primaries can be represented within the matrix A either through a 3×3 identity matrix or adjoined to the matrix A without affecting the linear independence of the columns.

The k×1 matrix N is any radiometric function. It may arise from the reflectance from a Munsell chip, a monochromatic light, or a standard illuminant. All that is required is that an equal energy source is the illuminant for the reflectance samples and the source for transmission samples.

The k×1 matrix N^{*} is defined to be the fundamental metamer of N. The k×1 matrix B is called the black metamer of N. The Wyszecki hypothesis relates these three matrices and serves to further define them, as is given by the following equation:

N=N^{*}+B (2)

The matrix Q, 3×1 matrix, is the tristimulous values of the radiometric function N with respect to the color mixing functions in A, as is given by the following equation:

Q=A′N (3)

Because a black metamer always has a tristimulous value of (0,0,0), the following equation is valid.

A′B=0 (4)

Equations 3 and 4 teach that the tristimulous values of a fundamental metamer are identical to the tristimulous values of all metamers within a given metameric set.

A new matrix Mₐ, a 3×3 matrix, can be defined according to the following equation:

Mₐ=A′A (5)

The matrix R, a k×k matrix, is defined by the following equation:

R=AMₐ⁻¹A′ (6)

The matrix R is called the orthogonal projector matrix.

It is known that the matrix R has invariance in the sense that R is invariant when computed by another A that has been multiplied by any 3×3 matrix with non-vanishing determinant.

The following result was derived by Cohen and Kappauf:

RN=N^{*} (7)

Using equations 3 and 7 the following result is obtained:

N−N^{*}=B (8)

It should also be noted that for any fundamental metamer, N^{*}, the following equation is true:

RN^{*}=N^{*} (9)

Equation 9 teaches that each row of R is the fundamental metamer of a monochromatic stimulus. Furthermore the black metamers of the monochromats are given by the following: I−R, where I is the k×k identity matrix.

An equation 10 can be derived where N is any radiometric function:

(I−R)N=B (10)

A k×3 matrix E is then defined by the following equation:

AMₐ⁻¹=E (11)

The matrix E has several interesting properties, but the key relationship for the black metamer protocol is given by the following equation:

EQ=N^{*} (12)

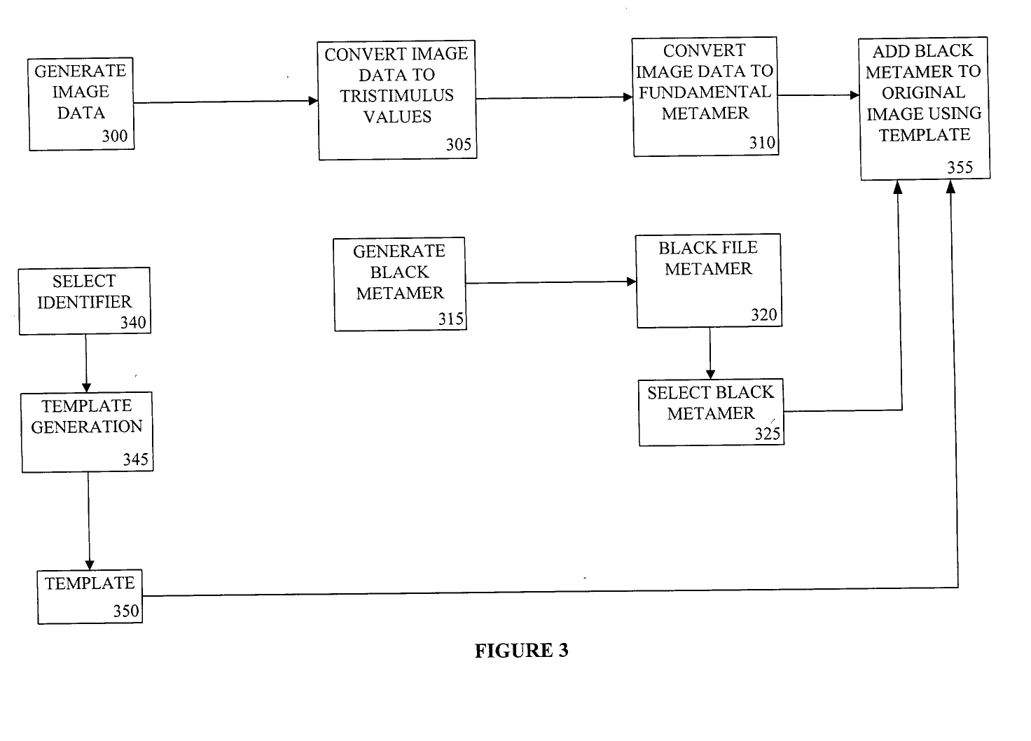

FIG. 3 illustrates a block diagram of an embodiment of the present invention using a black metamer.

As illustrated in FIG. 3, the process begins with the originator generating the original copy of the digital image 300, converting the image data of each pixel from radial form to tristimulous form 305, and converting the tristimulous values of each pixel to metamer form 310. A black metamer is generated 315, and retained in a file 320. A black metamer is selected from the file 325. Additionally, an identifier is selected 340. Next, a template is generated 345 and saved 350. The selected black metamer and the template are then used to add the identifier to the original image 355 by modifying the pixels of the original image as indicated by the template.

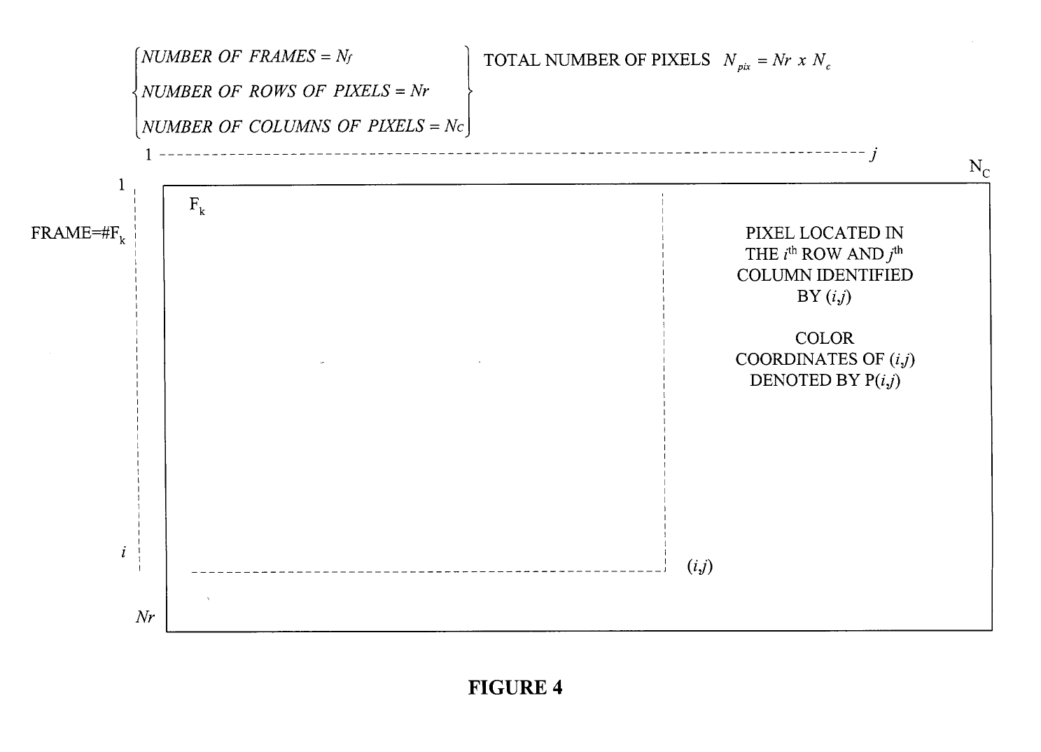

FIG. 4 contains a block diagram illustrating the important parameters of the digital image that is generated by the originator. As is illustrated by FIG. 4, the total number of frames is denoted by N_{f}. The number of rows is denoted by Nᵣ and the number of columns is denoted by N_{c}. Therefore the total number of pixels per individual frame is Nₚᵢₓ=Nᵣ×N_{c} FIG. 4 also illustrates the location of the pixel, (i,j) inside an individual frame. Pixel (i,j) is located at the intersection of the i^{th} row and j^{th} column. The frame that is described in FIG. 4 is the k^{th} frame and is denoted in the following by Fₖ. P(i,j) represents the color coordinates of (i,j), for example the RGB coordinates of the pixel.

The originator generates N_{f} frames of the original digital copy each consisting of Nᵣ rows and N_{c} columns of pixels.

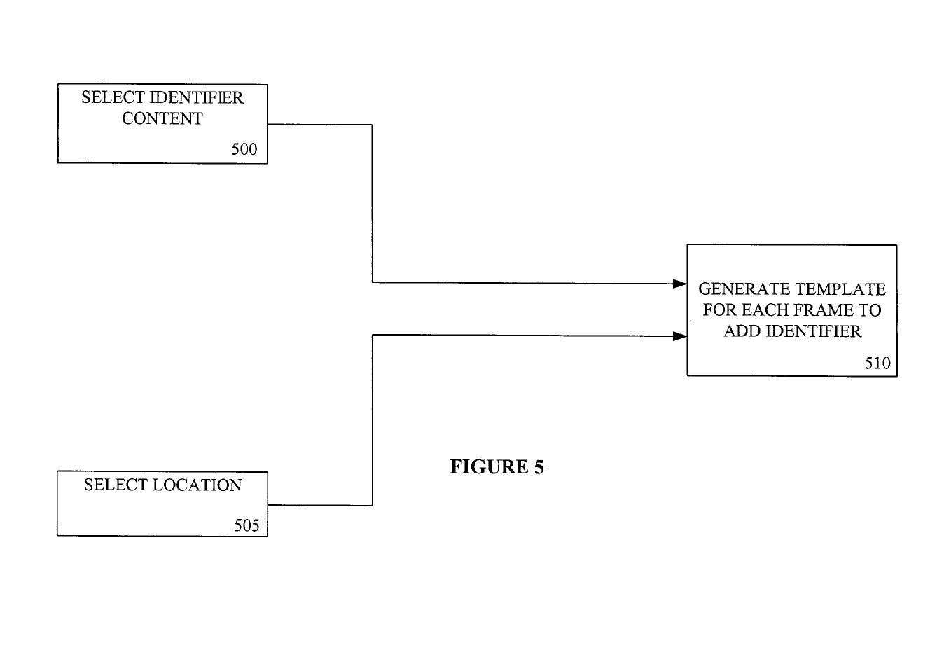

FIG. 5 contains a flow diagram illustrating the protocol for the development of a template. The originator selects the content of the identifier to be added to the original image 500, and then selects a location in the original frame for content of identifier 505. By way of example and not as a limitation, an identifier may be text or an image. The template 510 comprises a set of pixels that are to be modified to add the content of the identifier to the original digital image. The template is denoted by PIXMOD. PIXMOD is described in the following equation:

PIXMOD={P(i₁,j₁), . . . , P(i_{n mod}, j_{n mod})} (13)

After selecting an identifier to be added and the mechanism of addition (e.g., watermark, fingerprint, steganography, or text), the originator generates a template of the pixels of the image to be modified. The template is described above in equation 13.

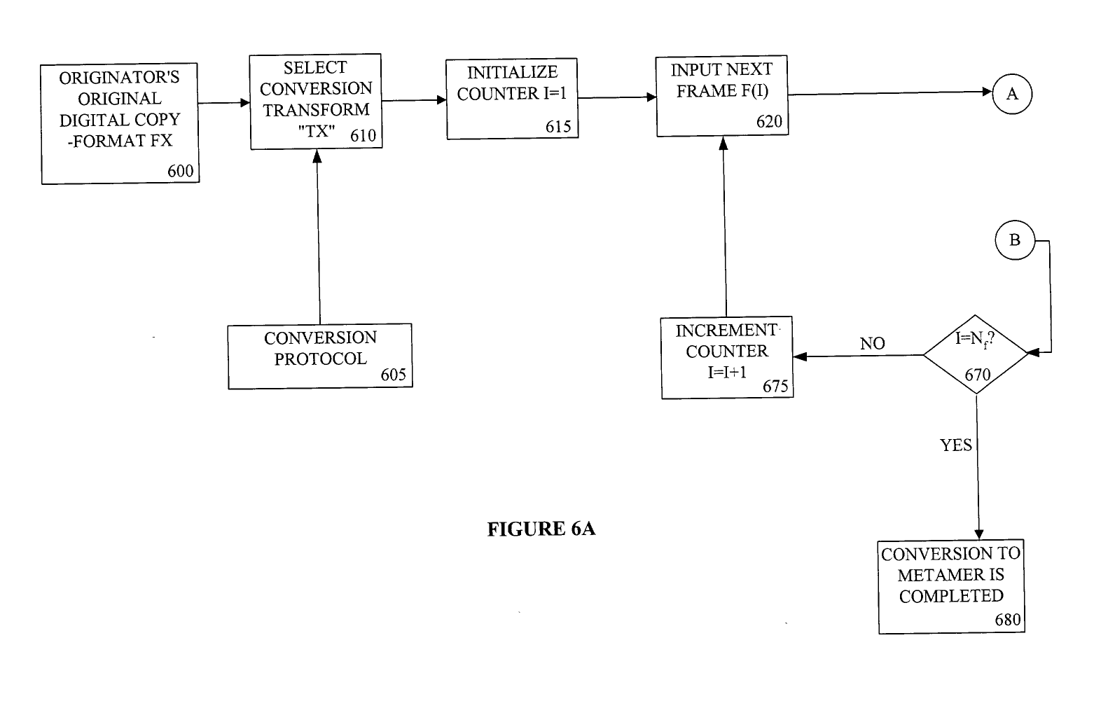

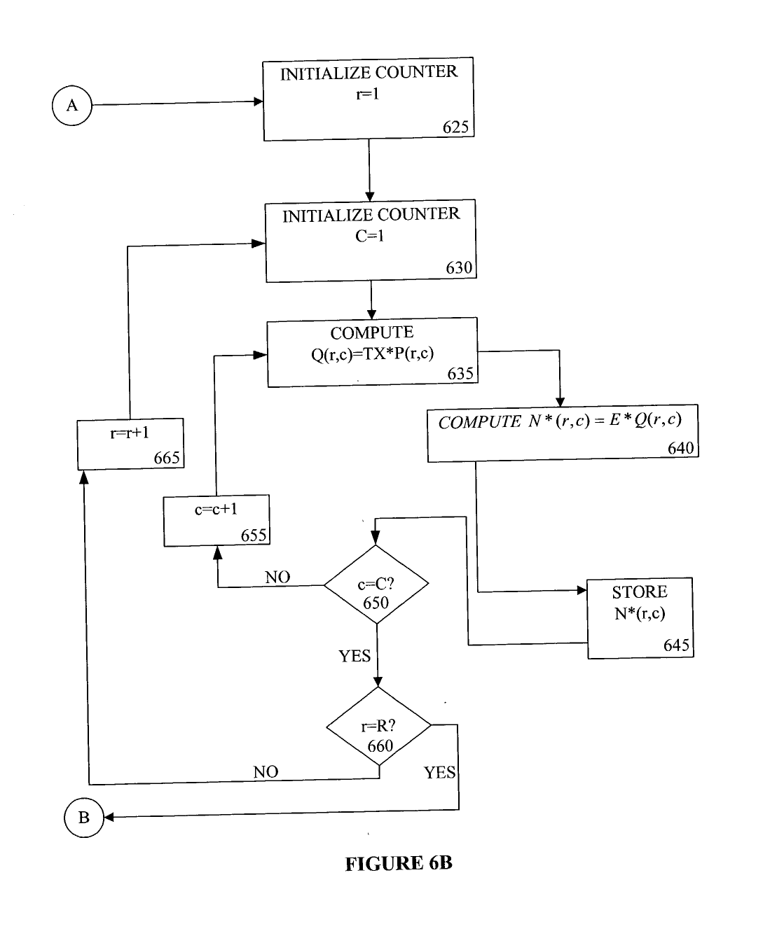

The next segment in present invention is to convert the original digital image copy to metameric form. This process is illustrated in FIGS. 6A and 6B.

Referring to FIG. 6A, the first step in this procedure is to input the original copy that was generated by the originator 600. This original copy was encoded using one of a number of available formats. There is a wide spectrum of choices for such encoding including but not limited to RGB, XYZ, CIE, and YIQ. Within these possible formats many subformats exist. For example, a number of different RGB encoding schema are available depending up the specific wavelengths selected for RGB. For the purposes of the present invention a transform “A” is used to convert from the originator selected encoding scheme 605 to tristimulous values 610. All encoding schema have such transformations.

By way of example, and not as a limitation, an exemplary embodiment of the present invention is described. In this exemplary embodiment, the encoding scheme selected by the originator is defined by the selection of wave lengths for RGB given by the following equation:

$$\{ \begin{matrix}R = 600 nm \\ G = 550 nm \\ B = 470 nm\end{matrix} \} \qquad ( 14 )$$

The transformation from RGB into the Q matrix, which gives the tristimulous values. This transformation is defined by the following equation:

$$Q = [ \begin{matrix}0.618637 & 0.252417 & 0.113803 \\ 0.367501 & 0.579499 & 0.052999 \\ 0.000466 & 0.005067 & 0.749913\end{matrix} ] [ \begin{matrix}R \\ G \\ B\end{matrix} ] \qquad ( 15 )$$

The next step in the procedure is to initialize the frame counter. This is accomplished by setting I=1 615.

The next step in the procedure is to input the next successive frame of the original digital image copy, F(I) 620. The frame is made up of pixels in R rows and C columns. In order to obtain a metamoric value, a tristimulous value must first be obtained. The conversion of the frame data into tristimulous data is accomplished by applying equation 15 on a pixel level. That is, a matrix Q(r,c) must be computed for each pixel. Then the resulting Q(r,c) is used to compute a fundamental metamer using equation 12, repeated below for convenience:

EQ=N^{*} (16)

Referring to FIG. 6B, this process begins setting r=1 625 and c=1 630. Q(r,c) is computed 635 and used to compute N*(r,c) 640. N* (r,c) is stored 645. A check is made to determine if c=C 650. If not, c is incremented by setting c=c+1 655 and the process continues at 635. If c=C, then a check is made to determine if r=R 660. If not, then r is incremented by setting r=r+1 665 and c is again set to c=1 660. If r=R, then the frame is completed. A check is made to determine if all frames from the original copy have been processed. This is accomplished by seeing if I=N_{f} 670 (FIG. 6A). If the answer is no, then the counter, I, is incremented by one 675 and the iterative processing is continued 620. If the answer is yes, then the conversion of the original copy of the digital image to metamer data has been completed 680.

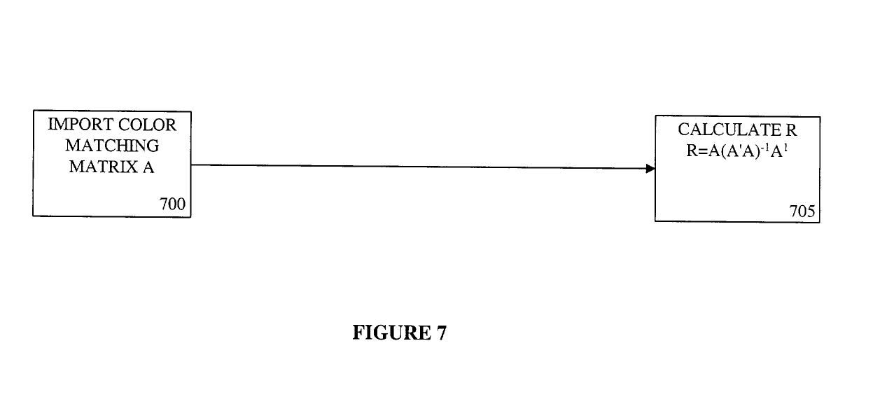

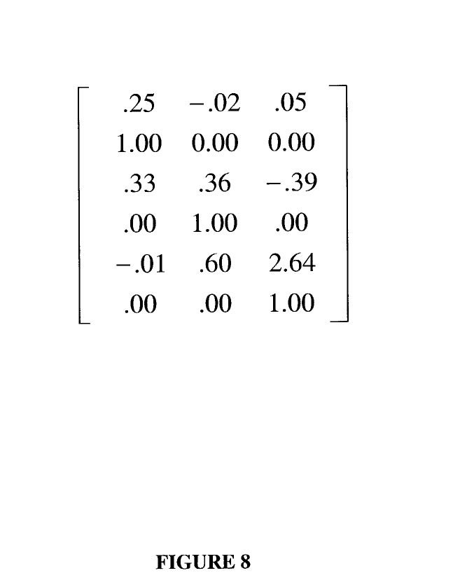

The next segment in the procedure is to generate an R matrix. Referring to FIG. 7, the first step in this procedure is to generate an A matrix 700. As previously noted an A matrix can be derived from CIE data. For the exemplary embodiment, data from the matrix disclosed in Cohen and Kappauf, p. 541 is used to form the 6 row matrix, A, as shown in FIG. 8.

The next step in the procedure is to derive the matrix R 705. Again referring to FIG. 7, the equation that generates R is shown below.

R=A(A′A)⁻¹A′ (17)

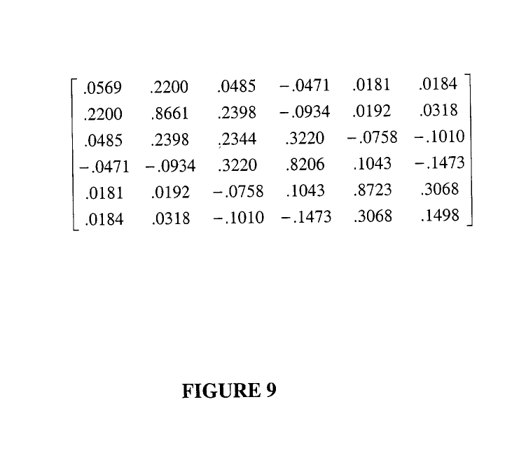

The R matrix derived from the A matrix of FIG. 8 is shown in FIG. 9.

The next segment in the procedure is to generate a large set of black metamers and then select one for usage in the exemplary embodiment.

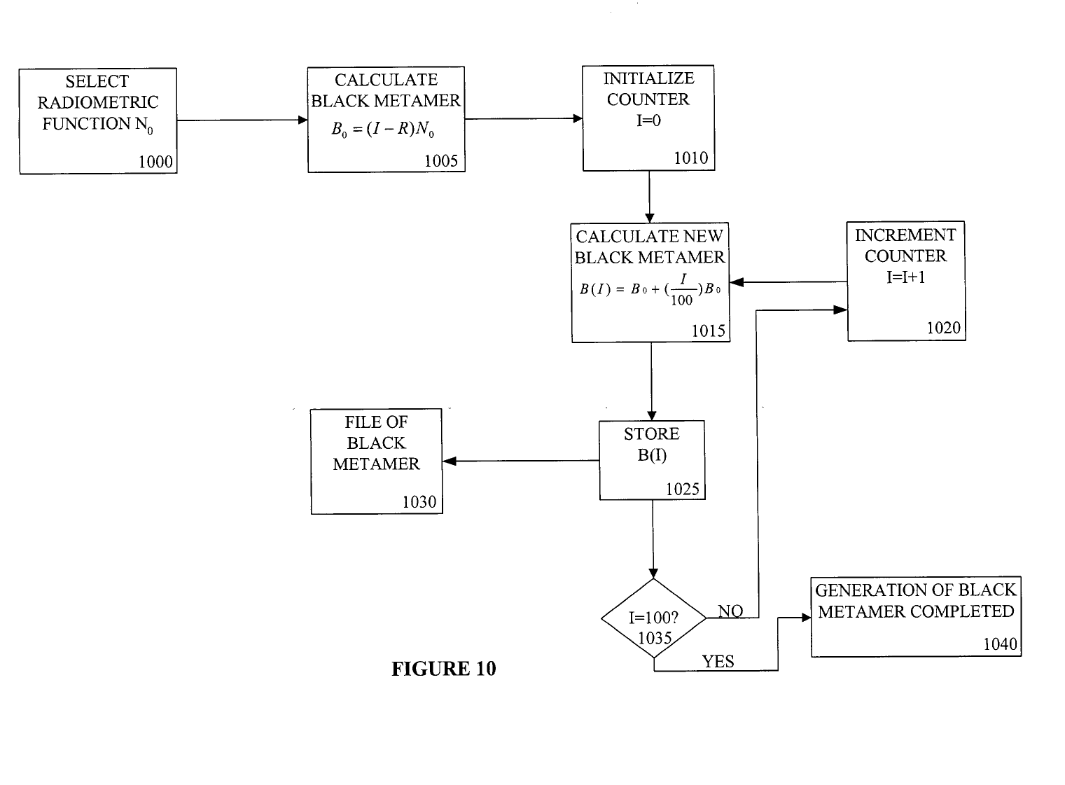

The functional diagram for the generation and selection of black metamers is contained in FIG. 10.

The first step is to select any non-monochromatic radiometric function, denoted by N₀ 1000. Radiometric functions are well known in the art of the present invention.

The next step in the procedure is to calculate the black metamer associated with the radiometric function N₀ 1005. This black metamer is denoted by B₀ and is calculated by using the following equation:

B₀=(I−R)N₀ (18)

The next step is to calculate a file of different black metamers. One could use this method to calculate any finite number of black metamers. For the purpose of this exemplary embodiment, the number of black metamers calculated is set to 100.

The creation of the file of black metamers begins with the initialization of the counter, I. This is accomplished by setting I=1 1010.

The next step in the procedure is to calculate a new black metamer 1015. This is accomplished by the following equation:

$$B ( I ) = {B}_{0} + ( \frac{I}{100} ) * {B}_{0} \qquad ( 19 )$$

The next step is to store B(I) 1025 in the file of black metamers 1030.

Once this step is accomplished a check is made to determine if all the black metamers have been generated. This is accomplished by checking if I=100 1035. If the answer is no, then the counter I is incremented by one 1020 and the iterative procedure for generating black metamers is continued 1015. If the answer is yes, then the generation of black metamers is completed 1040.

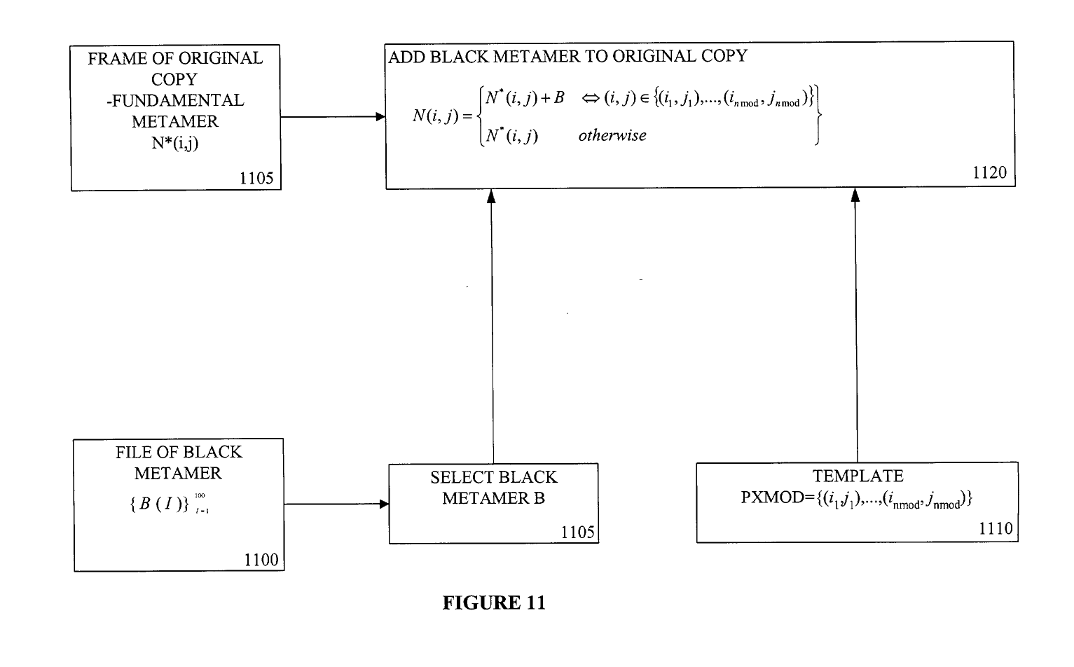

The next step in the protocol for black metamers is to add a selected black metamer to the original image using a selected template. A flow diagram for this process is contained in FIG. 11. As illustrated in FIG. 11, this process comprises adding the selected black metamers to the fundamental metamers for each pixel in the template. Otherwise the fundamental metamer for a pixel in the original image is left unchanged.

The first step in the procedure is to select a black metamer 1105 from the file of black metamers 1100. The next step in the procedure is the addition of black metamers 1120 for those pixels previously selected by the originator and contained in the template 1110. This is accomplished using the following equation:

$$N ( i , j ) = \{ \begin{matrix}{N}^{*} ( i , j ) + B ⇔ ( i , j ) ∈ \{ ( {i}_{1} , {j}_{1} ) , … , ( {i}_{n mod} , {j}_{n mod} ) \} \\ {N}^{*} ( i , j ) otherwise\end{matrix} \} \qquad ( 20 )$$

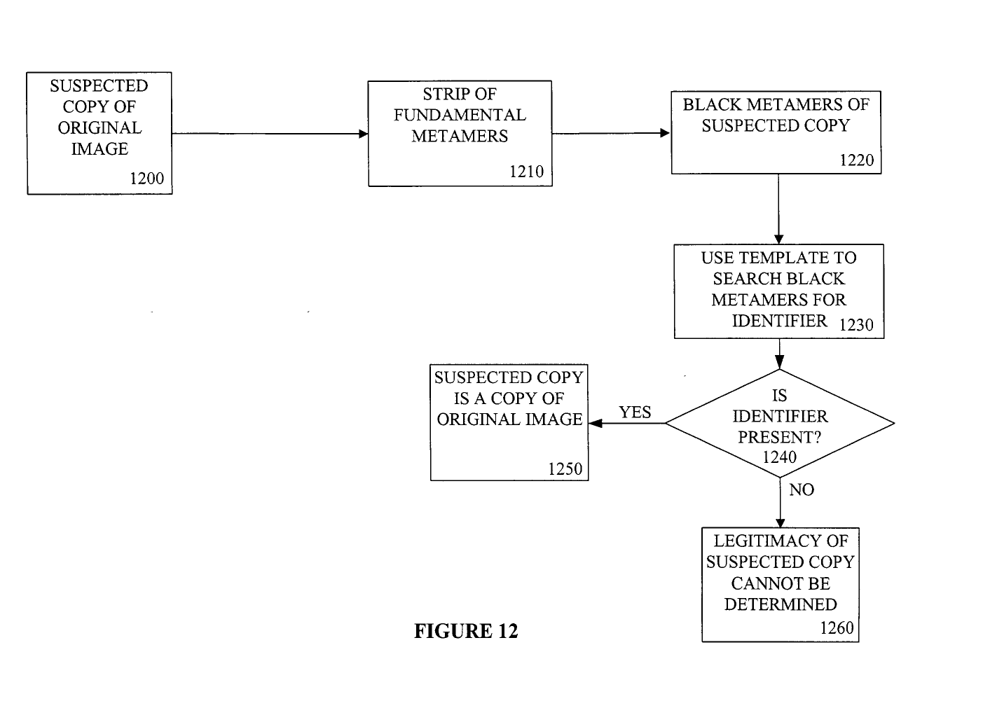

FIG. 12 illustrates a process for determining whether an image is an is a copy of another image. Referring to FIG. 12, a suspected copy of an original image 1200 is stripped of all fundamental metamers 1210 to reveal only the black metamers of the suspected copy 1220. Using the template and the recovered black metamers of the suspected copy 1230, the content of the black metamers are then analyzed 1240 to determine if the identifier is present. If the identifier is present, then the suspected copy is in fact a copy of the original image 1250. Depending on the content of the identifier, the identifier imprinted into the unauthorized copy can be used to determine when and where the unauthorized copy was made. For example, the identifier may include a time and date stamp and a projection location code. If the identifier is not present, then the legitimacy of the copy cannot be determined in accordance with the present invention 1260.

As previously noted, without the original image or the template used to imprint the original image, it is extremely difficult to detect the presence of the identifiers imprinted in the original image using black metamers. In another embodiment of the present invention, this attribute of black metamers is used for steganography, the process wherein secret messages are hidden in innocuous images passed between two or more people. The sender takes an image, which both he and the recipient(s) have, and places his secret message within the image using black metamers. The recipient subtracts the pristine image from the received image to obtain the secret message. Any interceptor of the message would see only the image and could not detect the presence of the hidden message much less the content. In still another embodiment of the present invention, the “message” is digital content. By way of illustration and not as a limitation, the digital content can include text, video, executable code, and audio information

A system and method of imprinting a digital image with an identifier using black metamers has now been illustrated. As described herein, the method of imprinting a digital image using black metamers provides an efficient and effective means of imprinting an identifier into the a digital image wherein the identifier can neither be detected or removed without access to the original image. In addition, a system and method for the use of black metamers in stenography has been illustrated. It will be understood by those skilled in the art of the present invention that the present invention may be embodied in other specific forms without departing from the scope of the invention disclosed and that the examples and embodiments described herein are in all respects illustrative and not restrictive. Those skilled in the art of the present invention will recognize that other embodiments using the concepts described herein are also possible.

What is claimed is:

1. A method of imprinting a digital image with an identifier using black metamers, wherein the digital image comprises pixels and wherein each pixel has associated therewith a fundamental metamer, the method comprising:
selecting a black metamer;
selecting an identifier;
adding the black metamer to the fundamental metamer of selected pixels of the digital image so as to imprint the digital image with the selected identifier.

2. The method according to claim 1 wherein adding the black metamer to the fundamental metamer of selected pixels of the digital image so as to imprint the digital image with the selected identifier comprises:
generating a template of pixels to be modified; and
applying the template to the digital image.

3. A method of acquiring an identifier from a digital image to which the identifier has been imprinted by the addition of a black metamer to the fundamental metamers of selected pixels of the digital image, the method comprising:obtaining the metamers of the selected pixels of the digital image:
obtaining the black metamers from the metamers of the selected pixels; and
obtaining the identifier from the black metamers.

4. A device for imprinting a digital image with an identifier, the device comprising a processor and a memory system, the memory system bearing software instructions adapted to enable the processor to implement the steps of:
obtaining a black metamer;
obtaining the identifier; and
adding the black metamer to the fundamental metamer of selected pixels of the digital image so as to imprint the digital image with the identifier.

5. The device according to claim 4 wherein the step of adding the black metamer to the fundamental metamer of selected pixels of the digital image so as to imprint the digital image with the selected identifier comprises:
generating a template of pixels to be modified; and
applying the template to the digital image.

6. A device for determining the presence of an identifer in digital image, the device comprising a processor and a memory system, the memory system bearing software instructions adapted to enable the processor to implement the steps of:
obtaining the metamers of the selected pixels of the digital image;
obtaining the black metamers from the metamers of the selected pixels; and
obtaining the identifier from the black metamers.

7. A device for imprinting a digital image with an identifier, the device comprising
a processor, and
a memory system, the memory system bearing software instructions adapted to enable the processor to implement the steps of:
receiving the digital image;
obtaining the fundamental metamer of a plurality of pixels of the digital image;
selecting a black metamer;
selecting an identifier;
adding the black metamer to the fundamental metamer of selected pixels of the digital image so as to imprint the digital image with the selected identifier.

8. The device according to claim 7 wherein the identifier is selected from the group consisting of watermarks, text, images, and digital fingerprints.

9. The device according to claim 7 wherein the software instructions further comprise software instructions to enable the processor to implement the steps of:
generating a template of pixels to be modified; and
applying the template to the digital image.

10. A method of sending a steganographic message using a digital image and black metamers, wherein the digital image comprises pixels having associated therewith a fundamental metamer, the method comprising:
selecting a black metamer;
selecting a steganographic message to imprint in the digital image;
adding the black metamer to the fundamental metamer of selected pixels of the digital image so as to imprint the digital image with the steganographic message.

11. The method as in claim 10 wherein the steganographic message is selected from the group consisting of text, graphics, executable code, video, audio, and multimedia content.

12. A method of receiving a steganographic message using a digital image and black metamers, wherein the digital image comprises selected pixels having associated therewith metamers to which a black metamer has been added so as to imprint the digital image with the steganogrphic message, the method comprising;
obtaining the black metamers from the metamers of the selected pixels; and
obtaining the stenographic meassage from the black metamers.
